(19) United States
(12) Patent Application Publication
(10) Pub. No.: US 2023/0142213 A1
(43) Pub. Date: May 11, 2023

(54) HARVESTER HIGH EFFICIENCY HEAT UTILIZATION DEVICE

(71) Applicant: Ming Li, Changsha (CN)

(72) Inventors: Ming Li, Changsha (CN); Jingjing Huang, Changsha (CN); Sihui Dai, Changsha (CN); Yongwei Xu, Shenzhen (CN); Heming Hu, Changsha (CN); Hongduo Zhang, Changsha (CN); Xu Xiao, Changsha (CN); Chaowu Wen, Changsha (CN); Jinqi Huang, Changsha (CN); Liang Zhang, Changsha (CN); Hao Xiong, Changsha (CN)

(73) Assignee: Ming Li, Changsha (CN)

(21) Appl. No.: 17/933,441

(22) Filed: Sep. 19, 2022

(30) Foreign Application Priority Data
Nov. 9, 2021 (CN) 202111317381.2
Jan. 14, 2022 (JP) 2022-004367

(51) Int. Cl. F26B 23/00; F23G 7/10; F26B 3/04; F26B 11/12; A01D 41/133; F01P 3/20

(52) U.S. Cl. CPC F26B 23/001; F23G 7/10; F26B 3/04; F26B 11/12; A01D 41/133; F01P 3/20; F23G 2206/203; F23G 2201/00; A23B 9/08

(57) ABSTRACT

A harvester high efficiency heat utilization device to be used in a harvester, includes: a drying chamber that dries grains of crops; a pipe that communicates with the drying chamber; a first heat exchanger provided in the pipe so as to communicate with an exhaust gas discharge port of an engine of the harvester; a combustion chamber that burns foliage of the crops; a second heat exchanger provided in the pipe so as to communicate with a high temperature gas discharge port of the combustion chamber; and a first blower that guides gas heat-exchanged by the first heat exchanger and the second heat exchanger to the drying chamber through the pipe.

### TECHNICAL FIELD

The present invention relates to a harvester high efficiency heat utilization device.

### BACKGROUND ART

JP2020-202761A discloses a harvester including a traveling device, a boarding unit, a threshing device, a grain tank, a harvesting unit, a transporting device, and a grain discharging device.

### SUMMARY OF INVENTION

The harvester according to JP2020-202761A is not equipped with a drying device and cannot dry grains. Therefore, it is necessary to transport the grains to a drying facility in order to dry them.

An object of the present invention is to provide a harvester high efficiency heat utilization device capable of drying grains by utilizing waste heat.

According to one aspect of the present invention, a harvester high efficiency heat utilization device used for a harvester is provided, the harvester high efficiency heat utilization device including: a drying chamber that dries crop grains; a pipe that communicates with the drying chamber; a first heat exchanger provided in the pipe so as to communicate with an exhaust gas discharge port of an engine of the harvester; a combustion chamber that burns foliage of the crop; a second heat exchanger provided in the pipe so as to communicate with a high temperature gas discharge port of the combustion chamber; and a first blower that guides the gas heat exchanged by the first heat exchanger and the second heat exchanger to the drying chamber through the pipe.

According to this aspect, the grain can be dried by utilizing the waste heat.

### BRIEF DESCRIPTION OF DRAWINGS

FIG. 1 is a schematic configuration diagram showing a harvester high efficiency heat utilization device according to the present embodiment.

### DESCRIPTION OF EMBODIMENTS

Hereinafter, an embodiment of the present invention (hereinafter referred to as the present embodiment) will be described with reference to the accompanying drawing.

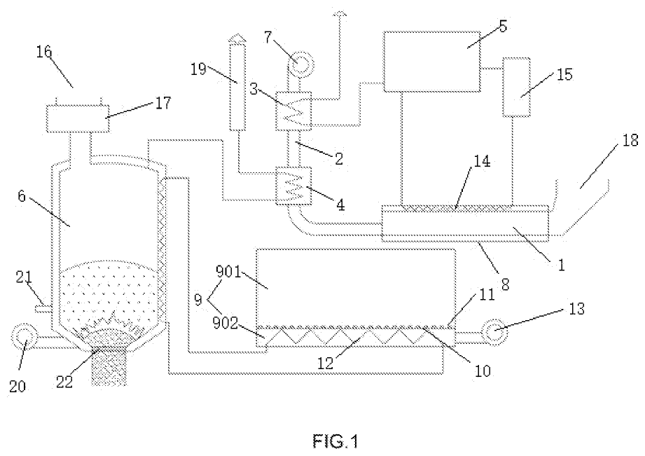

First, a harvester high efficiency heat utilization device according to the present embodiment will be described in detail with reference to FIG. 1.

FIG. 1 is a schematic configuration diagram showing the harvester high efficiency heat utilization device according to the present embodiment.

As shown in FIG. 1, the harvester high efficiency heat utilization device is provided in a harvester to be used in the harvester. The harvester is driven by an engine 5 to run. The harvester high efficiency heat utilization device includes a drying chamber 1, a pipe 2, a first heat exchanger 3, a combustion chamber 6, a second heat exchanger 4, a first blower 7, a spiral conveying cylinder 8, and a storage tank 9.

The drying chamber 1 primarily dries grains of crops. Specifically, the drying chamber 1 includes a cavity of the spiral conveying cylinder 8 provided with spiral conveying blades (not shown) on an inner peripheral surface thereof and rotatably provided on a fixed cylinder (not shown). The spiral conveying cylinder 8 is rotationally driven by a drive source such as a motor. In the spiral conveying cylinder 8, an input port is connected to a hopper 18 and an output port is connected to an input port of the storage tank 9.

The pipe 2 communicates with the drying chamber 1 (spiral conveying cylinder 8). The first heat exchanger 3 is provided in the pipe 2 so as to communicate with an exhaust gas discharge port (not shown) of the engine 5 via, for example, a communication passage. The combustion chamber 6 burns foliage of the crops (hereinafter, also simply referred to as foliage). The second heat exchanger 4 is provided in the pipe 2 so as to communicate with a high temperature gas discharge port (not shown) of the combustion chamber 6 via, for example, a communication passage. The first blower 7 guides gas heat-exchanged by the first heat exchanger 3 and the second heat exchanger 4 to the drying chamber 1 through the pipe 2. The first heat exchanger 3 and the second heat exchanger 4 are provided along a direction in which the gas flows in order. That is, the first heat exchanger 3 is provided between the first blower 7 and the second heat exchanger 4.

According to this configuration, it is possible to implement drying of the grains in the drying chamber 1 (spiral conveying cylinder 8). Specifically, residual heat of the engine 5 (residual heat due to high temperature exhaust gas of the engine 5) and combustion heat due to combustion of the foliage are exchanged with air in the pipe 2 by the first heat exchanger 3 and the second heat exchanger 4, respectively, and then guided to the drying chamber 1 (spiral conveying cylinder 8) by the first blower 7, so that the grains are dried in the drying chamber 1 (spiral conveying cylinder 8). As a result, since a high water content of the grains due to weather such as rain can be reduced by effectively utilizing the residual heat of the engine 5 and the combustion heat generated by the combustion of the foliage, loss of the grains and safety of the grains can be ensured, and energy saving can be achieved. By incinerating foliage with a high heavy metal content, cost of recovering the foliage can be significantly reduced, environmental pollution caused by heavy metals can be reduced, and incinerated foliage can be used as fertilizers.

One end, as a downstream end, of the pipe 2 is communicated with the output port of the drying chamber 1 (spiral conveying cylinder 8), and the other end, as an upstream end, of the pipe 2, is provided with the first blower 7. As a result, in the drying chamber 1 (spiral conveying cylinder 8), a blowing direction by the first blower 7 and a grain conveying direction by rotation of the spiral conveying cylinder 8 are opposite to each other. Therefore, the grains being transported can be effectively dried, and a water content of the grains can be reliably reduced particularly in the vicinity of the output port of the spiral conveying cylinder 8.

An inner peripheral surface of the spiral conveying cylinder 8 is provided with stirring plates (not shown) having a height lower than that of the spiral conveying blades. The stirring plates are provided offset from the spiral conveying blades so as to form a predetermined angle (for example, an acute angle) with the spiral transport blades. Thereby, by floating the grains in a conveying process, a contact time and a contact area between the grains and hot air in the spiral conveying cylinder 8 can be increased. Therefore, the water content of the grains can be efficiently removed.

As shown in FIG. 1, the storage tank 9 is a container that stores the grains conveyed by the rotation of the spiral conveying cylinder 8. The storage tank 9 includes a partition plate 10, a storage chamber 901 located above the partition plate 10, and an air heating chamber 902 located below the partition plate 10. The partition plate 10 is uniformly formed with a plurality of through holes 11. The through holes 11 are formed such that the grains cannot pass through. Therefore, it possible to prevent the grains from passing through the through holes 11 and entering the air heating chamber 902.

The harvester high efficiency heat utilization device further includes a third heat exchanger 12 and a second blower 13. The third heat exchanger 12 is provided in the air heating chamber 902 so that a part thereof surrounds an outer periphery of the combustion chamber 6. The second blower 13 guides gas heat-exchanged by the third heat exchanger 12 to the storage chamber 901. The second blower 13 is provided at an introduction port of the air heating chamber 902.

A part of the third heat exchanger 12 surrounding the outer periphery of the combustion chamber 6 is heated by the combustion chamber 6 and then heat thereof is exchanged in the air heating chamber 902 to heat air in the air heating chamber 902. Then, the heated air is guided to the grains deposited in the storage chamber 901 through the through holes 11 by the second blower 13, and the grains can be secondarily dried to further remove the water content of the grains.

An outer periphery of the spiral conveying cylinder 8 is provided with a fourth heat exchanger 14. That is, the spiral conveying cylinder 8 is rotatably supported on an inner periphery of the fourth heat exchanger 14. In the fourth heat exchanger 14, an input port is connected to a cooling water output port of the engine 5, and an output port is connected to an input port of a cooler 15 that cools the engine 5. An output port of the cooler 15 is connected to a cooling water input port of the engine 5 so that the engine 5 is cooled.

Water heated by the engine 5 is output from the cooling water output port of the engine 5 (the input port of the fourth heat exchanger 14) to the fourth heat exchanger 14. The fourth heat exchanger 14 exchanges heat with the heated water, and outputs the heat-exchanged water to the cooler 15 via the input port of the cooler 15 (the output port of the fourth heat exchanger 14). At the same time, the fourth heat exchanger 14 heats the outer periphery of the spiral conveying cylinder 8 as a whole by using heat generated by heat exchange (that is, the residual heat of the engine 5). Then, the cooler 15 cools output water, and outputs the cooled water to the engine 5 via the cooling water input port of the engine 5 (the output port of the cooler 15). As a result, the grains in the spiral conveying cylinder 8 can be evenly dried by the residual heat of the engine 5, so that the water content of the grains can be quickly removed.

An inlet 16 is formed in an upper part of the combustion chamber 6, and a crusher 17 that crushes the foliage is provided at the inlet 16. As a result, the crusher 17 crushes the foliage, so that flammability of the foliage can be improved. The second heat exchanger 4 communicates with a gas processor 19. Exhaust gas generated by burning the foliage in the combustion chamber 6 is output to the gas processor 19 via the second heat exchanger 4. As a result, the exhaust gas is filtered by the gas processor 19 and discharged to outside.

A blower 20 for supplying air to the combustion chamber 6 and a fuel inlet 21 for replenishing fuel are provided on a lower side surface of the combustion chamber 6. At a lower end of the combustion chamber 6, a slag discharge port 22 with a filter for discharging slag as an incinerator of the foliage is formed. Then, while the harvester is running, the harvester high efficiency heat utilization device can discharge the slag as it is as fertilizer through the slag discharge port 22. A heat insulating layer is provided on an outer wall of the combustion chamber 6 to prevent loss of the combustion heat.

(Functions and Effects)

Next, main functions and effects of the present embodiment will be described.

The harvester high efficiency heat utilization device according to the present embodiment is a harvester high efficiency heat utilization device used in a harvester, including: the drying chamber 1 that dries the crop grains; the pipe 2 that communicates with the drying chamber 1; the first heat exchanger 3 provided in the pipe 2 so as to communicate with the exhaust gas discharge port of the engine 5 of the harvester; the combustion chamber 6 that burns the foliage of the crop; the second heat exchanger 4 provided in the pipe 2 so as to communicate with the high temperature gas discharge port of the combustion chamber 6; and the first blower 7 that guides the gas heat exchanged by the first heat exchanger 3 and the second heat exchanger 4 to the drying chamber through the pipe 2.

According to this configuration, the residual heat of the engine 5 (the residual heat due to the high temperature exhaust gas of the engine 5) and the combustion heat due to the combustion of the foliage are exchanged with air in the pipe 2 by the first heat exchanger 3 and the second heat exchanger 4, respectively, and then guided to the drying chamber 1 (spiral conveying cylinder 8) by the first blower 7, so that the grains are dried in the drying chamber 1 (spiral conveying cylinder 8). As a result, since the high water content of the grains due to weather such as rain can be reduced by effectively utilizing the residual heat of the engine 5 and the combustion heat generated by the combustion of the foliage, the loss of the grains and the safety of the grains can be ensured, and energy saving can be achieved. By incinerating the foliage with a high heavy metal content, the cost of recovering the foliage can be significantly reduced, environmental pollution caused by heavy metals can be reduced, and the incinerated foliage can be used as fertilizers.

In the present embodiment, the drying chamber 1 includes the cavity of the spiral conveying cylinder 8 provided with the spiral conveying blades on the inner peripheral surface thereof and rotatably provided, and the storage tank 9 that stores the grains conveyed by the rotation of the spiral conveying cylinder 8 is also provided. In the spiral conveying cylinder 8, the output port thereof communicates with one end of the pipe 2 and the input port of the storage tank 9.

According to this configuration, in the drying chamber 1 (spiral conveying cylinder 8), the blowing direction by the first blower 7 and the grain conveying direction by the rotation of the spiral conveying cylinder 8 are opposite to each other. Therefore, the grains being transported can be effectively dried, and the water content of the grains can be reliably reduced particularly in the vicinity of the output port of the spiral conveying cylinder 8.

In the present embodiment, the storage tank 9 includes the partition plate 10 formed with the plurality of through holes 11, the storage chamber 901 located above the partition plate 10, and the air heating chamber 902 located below the partition plate 10, and further includes the third heat exchanger 12 provided in the air heating chamber 902 so that a part thereof surrounds the outer periphery of the combustion chamber 6, and the second blower 13 that guides the gas heat-exchanged by the third heat exchanger 12 to the storage chamber 901.

According to this configuration, a part of the third heat exchanger 12 surrounding the outer periphery of the combustion chamber 6 is heated by the combustion chamber 6 and then the heat thereof is exchanged in the air heating chamber 902 to heat the air in the air heating chamber 902. Then, the heated air is guided to the grains deposited in the storage chamber 901 through the through holes 11 by the second blower 13, and the grains can be secondarily dried to further remove the water content of the grains.

In the present embodiment, the fourth heat exchanger 14 is further provided on the outer periphery of the spiral conveying cylinder 8 such that the input port thereof is connected to the cooling water output port of the engine 5, and the output port thereof is connected to the input port of the cooler 15 that cools the engine 5. The output port of the cooler 15 is connected to the cooling water input port of the engine 5 so that the engine 5 is cooled.

According to this configuration, the fourth heat exchanger 14 heats the outer periphery of the spiral conveying cylinder 8 as a whole by using the heat generated by the heat exchange (that is, the residual heat of the engine 5), so that the grains in the spiral conveying cylinder 8 can be evenly dried by the residual heat of the engine 5, and therefore the water content of the grains can be quickly removed.

In the present embodiment, the gas processor 19 communicated with the second heat exchanger 4 is also provided.

According to this configuration, the exhaust gas is filtered by the gas processor 19 and discharged to the outside.

In the present embodiment, the combustion chamber 6 includes the inlet 16 and the crusher 17 that is provided at the inlet 16 and for crushing the foliage of crops.

According to this configuration, the crusher 17 crushes the foliage, so that the flammability of the foliage can be improved.

Although the embodiment of the present invention has been described above, the above-mentioned embodiment is merely a part of application examples of the present invention, and does not mean that the technical scope of the present invention is limited to the specific configurations of the above-mentioned embodiment.

The present application claims priorities of Chinese Patent Application No. 202111317381.2 filed with the China Patent Office on Nov. 9, 2021, and Japanese Patent Application No. 2022-4367 filed to the Japan Patent Office on Jan. 14, 2022, and all the contents of which are hereby incorporated by reference.

1. A harvester high efficiency heat utilization device to be used in a harvester, comprising:
a drying chamber that dries grains of crops;
a pipe that communicates with the drying chamber;
a first heat exchanger provided in the pipe so as to communicate with an exhaust gas discharge port of an engine of the harvester;
a combustion chamber that burns foliage of the crops;
a second heat exchanger provided in the pipe so as to communicate with a high temperature gas discharge port of the combustion chamber; and
a first blower that guides gas heat-exchanged by the first heat exchanger and the second heat exchanger to the drying chamber through the pipe.

2. The harvester high efficiency heat utilization device according to claim 1, further comprising:
a storage tank that stores the grains conveyed by rotation of a spiral conveying cylinder, wherein
the drying chamber includes a cavity of the spiral conveying cylinder provided with spiral conveying blades on an inner peripheral surface thereof and rotatably provided, and
an output port of the spiral conveying cylinder communicates with one end of the pipe and an input port of the storage tank.

3. The harvester high efficiency heat utilization device according to claim 2, further comprising:
a third heat exchanger provided in an air heating chamber such that a part thereof surrounds an outer periphery of the combustion chamber; and
a second blower that guides gas heat-exchanged by the third heat exchanger to a storage chamber, wherein
the storage tank includes:
a partition plate formed with a plurality of through holes,
the storage chamber located above the partition plate, and
the air heating chamber located below the partition plate.

4. The harvester high efficiency heat utilization device according to claim 3, further comprising:
a fourth heat exchanger provided on an outer periphery of the spiral conveying cylinder such that an input port thereof is connected to a cooling water output port of the engine, and an output port thereof is connected to an input port of a cooler that cools the engine, wherein
an output port of the cooler is connected to a cooling water input port of the engine so that the engine is cooled.

5. The harvester high efficiency heat utilization device according to claim 1, further comprising:
a gas treatment device that communicates with the second heat exchanger.

6. The harvester high efficiency heat utilization device according to claim 1, wherein the combustion chamber includes:
an inlet, and
a crusher that is provided at the inlet and for crushing the foliage of crops.
